(19) United States
(12) Patent Application Publication
(10) Pub. No.: US 2014/0279614 A1
(43) Pub. Date: Sep. 18, 2014

(54) METHODS AND SYSTEMS FOR DETECTING, PREVENTING AND MONIETIZING ATTEMPTED UNAUTHORIZED USE AND UNAUTHORIZED USE OF MEDIA CONTENT

(71) Applicants: Wayne D. Lonstein, Ellenville, NY (US); Julie C. Lonstein, Ellenville, NY (US)

(72) Inventors: Wayne D. Lonstein, Ellenville, NY (US); Julie C. Lonstein, Ellenville, NY (US)

(21) Appl. No.: 13/829,865

(22) Filed: Mar. 14, 2013

(51) Int. Cl. G06Q 30/00

(52) U.S. Cl. CPC G06Q 30/0185
USPC 705/318

(57) ABSTRACT

A method of detecting, preventing and monetizing unauthorized use and attempted unauthorized use of media content. In one embodiment, the method comprises providing a website containing what appears to be unlicensed or otherwise illegal media content; providing a user with the ability to view, hear or access at least a portion of the unlicensed or otherwise illegal media content; informing the user that the media content might be unlicensed or otherwise illegal or that, viewing, access, use or distribution of the media content might be illegal; and receiving contact or location information for the user that attempts to view, access, use or distribute the media content provided on the website.

### RELATED APPLICATION

This application is a continuation in part of U.S. patent application Ser. No. 13/118,324, filed on May 27, 2011, the contents of which are hereby incorporated by reference herein in its entirety.

### FIELD OF THE DISCLOSURE

The present invention generally relates to systems and methods for detecting and preventing unauthorized use of media content and at the same time monetizing the media content, and other protectable media content, that the user is trying to use without authorization or permission. More particularly, the present invention relates to methods and systems to detect, prevent and monetize attempted unauthorized use of media content by providing seemingly illegal, unlicensed or proprietary media content to users who desire it and obtaining location and contact information from those users who attempt to access, download, view, hear or use the media content.

### BACKGROUND

The internet and increases in bandwidth and sharing of information have allowed users to improperly have access to protected media content that can easily and readily be accessed without remuneration to a content owner or licensor.

The proliferation of the internet and popularization of mobile phones, PDA's Tablet's, I-Pad's, Smart or Web Enabled Televisions have given rise to a largely untapped market place in order to conduct electronic commerce involving various types of intellectual property.

One of the major problems with all online content is unauthorized use of the content without payment to the owner or licensor. This can be accomplished by various means, including but not limited to, file sharing, peer-to-peer sharing, website hacking, credit card identity theft, jail-breaking, illegal duplication or streaming of protected media content online.

Content owners do not have a method of identifying end users who, knowingly or have reason to know, illegally access proprietary media content due to a semi-anonymous nature of internet, the numerous ways and locations that the media and content can be accessed, the incredible speed by which the content can be accessed and/or disseminated, often with little to no trace, due to the ubiquitous availability of public internet access.

At a certain price point, users will choose to purchase and/or obtain a license from the content owner instead of illegally accessing it. The price the user is willing to pay will increase if the user comprehends the risks associated with illegally accessing the media content and will have to deal with the inherent risk and associated costs of civil and/or criminal litigation. Unauthorized use of media content, whether it be online content in the pay-per-view realm or otherwise, results in significant revenue losses and costs for television programmers, promoters and content owners who make significant investments in development, marketing and commercial exploitation of the media content. By applying a free market approach and pricing the media content at a fair price that the user is willing to pay, they maximize the revenue that will be received for the media content. Additionally, by offering discounted pricing on bundled or larger quantities of media content, the user is even more motivated and inclined to purchase and consume additional media content. All of these incentives, when combined with the threat of being caught and punished for stealing media content, discourage the unauthorized use and illegal dissemination of protected media content.

Accordingly, there exists a need for improved systems and methods that allows content owners and licensees to detect and prevent unauthorized use of media content and obtain remuneration from those that try to illegally steal media content.

### SUMMARY OF THE INVENTION

In one embodiment of the present disclosure, a method of detecting and preventing unauthorized use of media content is provided. The method comprises (1) providing a website, a web application, a mobile application, or other similar technology containing what appears to be unlicensed or otherwise illegal media content, (2) providing a user with the ability to view, hear, use or access at least a portion of the unlicensed or otherwise illegal media content, (3) informing the user that the media content might be unlicensed or otherwise illegal or that, assessing, viewing, hearing, downloading, using or distributing the media content might be illegal; and receiving contact or location information for the user that attempts to access, view, hear, download, use or distribute the media content provided on the website.

In one aspect of at least one embodiment of the present disclosure, the method further comprises acquiring rights to sell, show or distribute the media content to the user from the one or more owners of the media content.

In another aspect of at least one embodiment of the present disclosure, the method further provides offering the user the ability to purchase rights to view, hear, access, disseminate or use the media content.

In yet another aspect of at least one embodiment of the present disclosure, the rights to view, hear, access, disseminate or use the media content are rights to a group of media content.

In yet another aspect of at least one embodiment of the present disclosure, the rights to the group of media content are offered at a discount.

In yet another aspect of at least one embodiment of the present disclosure, the method further comprises interrupting the user's ability to view, hear, use or access at least a portion of the unlicensed or otherwise illegal media content.

In yet another aspect of at least one embodiment of the present disclosure, the method further comprises notifying the user, using the received contact or location information, of an alternative location where the media content may be viewed, heard, used or accessed and providing, to the user will the ability to continue viewing, hearing, using or accessing the content for a period of time.

In another embodiment of the present disclosure, a system for detecting and preventing unauthorized use of media content is provided. The system comprises an online website containing a link to media content, a streaming media server in communication with the online website, a web server in communication with the streaming media server and where, upon receipt of information indicating a user is trying to or has accessed, downloaded, viewed or heard the media content, the website, streaming media server or web server prevents a user from accessing, viewing, hearing or downloading the media content served by the media server or web server and the website, web server or streaming media serve receives contact or location information for the user.

In one aspect of at least one embodiment of the present disclosure, streaming is content sent in compressed form of live broadcast over the internet and/or any form of electronic communication or transmittal and displayed by the viewer in real time.

In yet another aspect of at least one embodiment of the present disclosure, streaming is content sent in any form of electronic communication or transmittal and displayed by the viewer in real time.

In yet another aspect of at least one embodiment of the present disclosure, the system further comprises a licensing payment module which allows the user to pay for a license to at least the media content and continue to access, download, view or hear the media content.

In yet another aspect of at least one embodiment of the present disclosure, the system further comprises a payment module wherein the payment module releases information regarding the user's contact or location information to the user and requests that the user pay for the media content.

In yet another aspect of at least one embodiment of the present disclosure, the user is notified that their actions are illegal and that payment for the media content will avoid further legal action.

In yet another embodiment of the present disclosure, a computer program product for detecting and preventing unauthorized use of media content is provided. The computer program comprises a computer readable storage medium having computer readable program code embodied therewith, the computer readable program code comprises a computer readable program code configured to instruct an application server to store media content sought to be protected, inform a user that the media content is unlicensed, proprietary or that use, access or dissemination of the media content is illegal, provide the user access to the media content and receive or obtain contact or location information for the user.

In yet another aspect of at least one embodiment of the present disclosure, the computer readable program code is further configured to instruct the application server to restrict or prevent the user's access to the media content and redirect the user to a payment module.

In yet another aspect of at least one embodiment of the present disclosure, the computer readable program code is further configured to instruct the application server to associate the user with location or contact information obtained from the user or from the user's access of the media content and store information relating to the user's activities to a database.

In yet another aspect of at least one embodiment of the present disclosure, the computer readable program code is further configured to instruct the application server to provide access to the media content for a limited time and provide the user with the ability to pay for at least the media content in order to continue to view, access, download or use the media content.

In another aspect of the present invention, a method of operating an online stream capture is provided comprising placing content sought to be protected on a website; providing access to the content to an unlicensed user, wherein the unlicensed user is a pirate; advising the pirate that the content is unlicensed or proprietary; receiving contact information for the pirate; and obtaining lawful remuneration from the pirate.

In yet another aspect of the present invention, an online stream capture system is provided comprising an online capture technology; a streaming media server in communication with the online capture technology; a web server in communication with the streaming media server and obscuring the streaming media server; and a kill switch module in communication with the online capture technology, the online capture technology operable to direct the streaming media server to store media content sought to be protected; direct the streaming media server to serve up media content; direct the kill switch module to reduce access to the media content for a user; advise the user that the media content is unlicensed or proprietary; receive contact information for the user; and obtain compensation from the user for accessing the media content.

In yet another aspect of the present invention, a computer program product for providing an online capture technology, the computer program product comprising a computer readable storage medium having computer readable program code embodied therewith, the computer readable program code comprising computer readable program code configured to instruct an application server to store media content sought to be protected; advise a user that the media content is unlicensed; provide the user access to the media content; receive identifying information for the user; and obtain compensation for the accessed media content.

In yet another aspect of at least one embodiment of the present invention, a method of providing an online capture system, the method comprising: 1) placing content sought to be protected on a website, web application, mobile application or similar technology, 2) providing access to the content to an unlicensed user, wherein the unlicensed user is a pirate, 3) advising the pirate that the content is unlicensed, 4) receiving contact information for the pirate and 5) obtaining payment from the pirate.

In yet another aspect of at least one embodiment of the present invention, a method of providing an online capture system further comprising acquiring rights from a content owner for the content sought to be protected.

In yet another aspect of at least one embodiment of the present invention, a method of providing an online capture system wherein the content is a portion of full length content.

In yet another aspect of at least one embodiment of the present invention, a method of providing an online capture system wherein the content is a reduced quality version of a full quality content.

In yet another aspect of at least one embodiment of the present invention, a method of providing an online capture system further comprising: 1) interrupting access to the content, 2) notifying the pirate, 3) using the received contact information, of an alternative location where the content may be accessed, and 4) providing, to the pirate, continued access to the content for a limited period of time.

In yet another aspect of at least one embodiment of the present invention, a method of providing an online capture system further comprising: 1) providing a user forum, 2) associating the pirate with an internet protocol address, and 3) providing a payment option to the pirate.

In yet another aspect of at least one embodiment of the present invention, a method of providing an online capture system further comprising: 1) obtaining at least one of a user's credit card information or a user's phone number, and 2) upgrading a user to a premium status.

In yet another embodiment of the present invention, a system of an online capture system, the system comprising: an online capture technology, a streaming media server in communication with the online capture technology, a web server in communication with the streaming media server and obscuring the streaming media server, and a kill switch module in communication with the online capture technology, the online capture technology operable to: direct the streaming media server to store media content sought to be protected, direct the streaming media server to serve up media content, direct the kill switch module to reduce access to the media content for a user, advise the user that the media content is unlicensed or proprietary; receive contact information for the user, and obtain compensation from the user for accessing the media content.

In yet another aspect of at least one embodiment of the present invention, a system of an online capture system wherein the online capture technology further comprises: a user manager, and a payment module.

In yet another aspect of at least one embodiment of the present invention, a system of an online capture system further comprising: a data archiving module, the data archiving module comprising a database server, wherein the online capture technology is operable to direct the database server to archive received contact information for the user.

In yet another aspect of at least one embodiment of the present invention, a system of an online capture system further comprising: a second streaming media server in communication with the online capture technology.

In yet another embodiment of the present invention, a computer program product for providing an online capture, the computer program product comprising: a computer readable storage medium having computer readable program code embodied therewith, the computer readable program code comprising: computer readable program code configured to instruct an application server to: store media content sought to be protected, advise a user that the media content is unlicensed or proprietary, provide the user access to the media content, receive identifying information for the user, and obtain compensation for the accessed media content.

In yet another aspect of at least one embodiment of the present invention, a computer program product for providing an online capture wherein the computer readable program code is further configured to instruct the application server to: activate a kill switch module, wherein activating the kill switch module removes access to the media content; and redirect the user to a payment module.

In yet another aspect of at least one embodiment of the present invention, a computer program product for providing an online capture wherein the computer readable program code is further configured to instruct the application server to: associate the user with forensic information obtained on the user's access of the media content; and store information relating to the user's activities to a database.

In yet another aspect of at least one embodiment of the present invention, a computer program product for providing an online capture wherein the computer readable program code is further configured to instruct the application server to: provide access to the media content for a limited time, and provide a premium status upgrade option to the user.

In yet another embodiment of the present invention, a system, method and computer program product for providing an online capture, wherein developing a platform that serves as a monetization system and an online payment source. In yet another aspect of at least one embodiment of the present invention wherein the monetization system and the online payment source include at least the online currency or debit card. In yet another aspect of at least one embodiment of the present invention, the debit card or online currency can be used across the board online with the ability to re-charge it as needed.

In yet another aspect of at least one embodiment of the present invention, a system, method and computer program product for providing an online capture, wherein the debit card or online currency can be made more valuable by providing preferred pricing negotiated with the content owners and providing discounts for various events, for example and not by way of limitation, NFL, NBA, NHL, MLB, UFC, WWE. In yet another aspect of at least one embodiment of the present invention, a system, method and computer program product for providing an online capture, wherein the debit card or online currency can also be used for providing discounts for other content including but not limited to Pandora, streamed live radio/video unrelated to sports, XM-Sirius online content, e-magazines, and newspapers.

In yet another aspect of at least one embodiment of the present invention, a system, method and computer program product for providing an online capture, wherein the debit card or cross branded currency is available by major card issuing companies such as American Express™, Visa™, MasterCard™ and Discover™.

In yet another aspect of at least one embodiment of the present invention, a system, method and computer program product for providing an online capture, wherein the debit card or online currency can be accessed universally allowing consumers and pirates to make reasonably priced multiple content purchases from one account.

In yet another embodiment of the present invention, a system, method and computer program product for providing an online capture, wherein pre-arranged bulk preferential pricing movies, music, printed and other media such as e-books are used. In yet another aspect of at least one embodiment of the present invention, a system, method and computer program product for providing an online capture, further providing discounted currency and luring the pirates to purchase the legally authorized content to deter unauthorized use by reducing the price.

In yet another aspect of at least one embodiment of the present invention, a system, method and computer program product for providing an online capture, wherein in addition to the bulk pricing, the pay-per-view card or online currency can offer the cross-over flexibility of being accepted by a broad spectrum of online content sellers making it a one stop shop for online content allowing auction or resale of currency on various online websites including but not limited to eBay™ and Stubhub™.

In yet another aspect of at least one embodiment of the present invention, a system, method and computer program product for providing an online capture, wherein the technology of the online capture is used to expose the relevant marketplace of pirates using snippets of content in order to lure them in and then providing targeted advertising to get the authorized content they were visiting at a much discounted rate.

In yet another aspect of at least one embodiment of the present invention, a system, method and computer program product for providing an online capture, wherein in addition to the targeted ads, the honeypot or other advertising sites can also generate immediate email, text messaging or IP tracing communication notice that will help entice prospective pirates to make the immediate and long term purchase.

In yet another aspect of at least one embodiment of the present invention, a system, method and computer program product for providing an online capture, wherein allowing various league owners and content owners to license the content to the online capture technology to quantify its pirate and legitimate markets and then mine the data from the online capture to contact and target the products to the suspected pirates.

In yet another aspect of at least one embodiment of the present invention, a system, method and computer program product for providing an online capture, wherein an application is developed for imbedding on mobile devices at the factory or as an add-on-application to be accessed later. In yet another aspect of at least one embodiment of the present invention, a system, method and computer program product for providing an online capture, wherein the mobile devices serve as a content viewer. In yet another aspect of at least one embodiment of the present invention, a system, method and computer program product for providing an online capture, wherein the QR (quick response) code or NFC (near field communication) of the mobile devices can be used as payment wallet for the card or online currency.

In yet another aspect of at least one embodiment of the present invention, a system, method and computer program product for providing an online capture, allowing multiple cross-platform branding by associating various accounts for example and not by way of limitation the frequent flier mileage accounts, bonus cash accounts and other rewards accounts.

In yet another aspect of at least one embodiment of the present invention, a system, method and computer program product for providing an online capture, wherein the online currency or debit card can be used for online, mobile or land based predictability business in sports or other ventures such as poker, online video game subscriptions etc.

In yet another aspect of at least one embodiment of the present invention, a system, method and computer program product for providing an online capture, wherein a generic card is provided which is unidentifiable by simple possession but can be authorized by fingerprint, facial recognition or retinal scan in later iterations for security purposes.

In yet another aspect of at least one embodiment of the present invention, a system, method and computer program product for providing an online capture, wherein online gaming sites, social media (for example Facebook® and Twitter®) are used to lure the pirate to access the website.

These and other features, aspects and advantages of the present invention will become better understood with reference to the following drawings, description and claims.

### BRIEF DESCRIPTION OF THE DRAWINGS

FIG. 1 is a schematic diagram of an online capture system according to an exemplary embodiment of the present invention.

FIG. 2 is schematic diagram of aspects of the online capture system shown in FIG. 1.

FIG. 3 is a schematic diagram of aspects of the online capture system shown in FIG. 1.

FIG. 4 is a process flow diagram of an online capture method according to an exemplary embodiment of the present invention.

FIG. 5 is a schematic diagram of aspects of the online capture method.

### DETAILED DESCRIPTION OF THE INVENTION

The following description is not to be taken in a limiting sense, but is made merely for the purpose of illustrating the general principles of the invention, since the scope of the invention is best defined by the following claims. Various inventive features are described below that can each be used independently of one another or in combination with other features.

Broadly, embodiments of the present invention generally provide a method of detecting and preventing unauthorized use of media content by providing a website, a web application, a mobile application, or other similar technology containing what appears to be unlicensed or otherwise illegal media content, providing a user with the ability to view, hear, use, access or access at least a portion of the unlicensed or otherwise illegal media content and informing the user that the media content might be unlicensed or otherwise illegal or that, viewing, hearing, downloading, using, accessing, sharing or distributing the media content might be illegal and receiving contact or location information for the user that attempts to view, hear, access, use or distribute the media content provided on the website.

For purposes of the present disclosure, media content shall include content, in any form and type, that is or can be protected through law or otherwise. The term “media” can refer to both the physical or virtual formats whereas the term “content” can refer to the information or message encoded on to a delivery-medium. Examples of media content include but are not limited to software, video, music, writings, and any other literary, musical, or artistic work presently available or created in the future.

Referring now to FIG. 1, a schematic diagram is shown of an online capture system 100 according to an exemplary embodiment of the present invention. Capture system 100 may have an online capture technology 102, which may be in communication with and invoke a plurality of modules and devices including, for example, a local server 104, a feed engine 106, a forum module 108, a reporting module 109, a tracking module 110, a payment module 112, an authentication module 113, a statistical module, 114, a display module 116, a phone verification module 117, a user module 118, an event module 120, a kill switch module 122, and a data archiving and retention module 126. Data archiving and retention module 126 may be in communication with and invoke a historical data review module 128 and a database server 130. The foregoing elements may provide an online capture technology 102 with the user interface and communication functionality to allow an online capture technology 102 to communicate with a third party video streaming server 124 or a user (not pictured). Streaming server 124 may be a web server, for example, configured to store and serve up streaming or static media for local server 104, which may be a web server or application server on which feed engine 106, for example, may reside. The online capturing technology 102 is a method of detecting, deflecting, or in some manner counteracting attempts at unauthorized access of information system such as a website or a personal computer. The online capturing technology 102 can be software, hardware or a monitored decoy website which is capable of gathering information from user who is accessing the information system.

According to some exemplary embodiments, an online capture technology 102, feed engine 106, forum module 108, reporting module 109, tracking module 110, payment module 112, authentication module 113, statistical module, 114, display module 116, phone verification module 117, user module 118, event module 120, kill switch module 122, and data archiving and retention module 126 may be software or hardware components embodied in an application server or a web server, presented through a website, a web application, a mobile application, or other similar technology, and configured to perform functions or execute tasks including, for example, invoking modules described herein, administering a media stream, controlling an online user forum, controlling reporting tasks, controlling user tracking sessions and information; managing user payment options and receipt thereof, performing user authentication, calculating usage statistics, controlling a display of website components, verifying a phone number, managing user settings, controlling website and user events, controlling user access to media; and archiving user information and statistics respectively.

Referring now to FIG. 2, a schematic diagram 200 of aspects of system 100 of FIG. 1 is shown. A kill switch module 202 may be in communication with, and invoke, a plurality of modules including, for example, an event module 204, a display module 206, a feed engine 208, and a forum module 210. When invoked by kill switch module 202, the plurality of modules 204, 206, 208, 210 may be configured to exhibit shutdown or inactive portions of the online capture website, web application, mobile application or other similar technology, display a predetermined message to a user, disrupt or alter a media feed, and activate a predetermined protocol on the user forums, respectively. The predetermined message may state that the website or application was taken offline and that users may find their content on an alternative location or website. Kill switch module 202 may be in communication with a user manager 212, which may invoke a notify users module 214 that may implement communication methods including, for example, email 216, short message service 218 (SMS), and social networking means including Twitter® 220 and Facebook® 222. User manager 212 and user module 118 may be configured to manage all aspects of a user profile including login information, geographic information, identity, email, locale, phone number, and address, for example.

Referring now to FIG. 3, a schematic diagram 300 is shown that illustrates a relationship between the modules and processes according to an exemplary embodiment of the present invention. A user 301 may be associated with identifying information 302 that may include but is not limited to an internet protocol (IP) address, a user agent, a geographic location, an email address, and a date/time stamp of any activity of user 301. A disclaimer may be presented to user 301 of his unlicensed access to content in step 304. User 301 may be given access to a website or application 306, which may have features including a low quality content feed 308a, an event list 308b, a user discussion forum 308c, a register 308d, and a login 308e. Activity or access of low quality content feed 308a may be documented in a log 310a. The foregoing features 308a-e may require a login, which invoke a login or register prompt 310b. Login 308e may be in communication with a user manager 312, which may enable a forum 318 or may make determinations including whether user data was completed 314 or an access level of a user 316. If user 301 has not completed all his user data, website or application 306 may be promoted through social networking means 330 (e.g. using Facebook®, Twitter®) that may target user 301. Services or content of website or application 306 may be promoted through listing/viewing posts 332 or posting/replying to a topic 334.

Modules including event lists 320, 321 may be activated, which may link to a high quality feed 322, and a medium quality feed 324 respectively, wherein event list 320 may be activated, and high quality feed 322 may be shown if it is determined that user 301 is a premium user. During all user 301 interactions with website 306, forensic information including the originating internet protocol (IP) address of user 301 may be recorded and paired with the user's account 328. Activity or access of high quality content feed 322 or medium quality feed 324 may be documented in logs 336 and 337 respectively.

According to some exemplary embodiments of the present invention, user 301 may be offered an option of premium services 338, which may include access to higher quality content, a broader range of content, access to full content, or access to view or use restricted aspects of the website, for example. Upon user 301 selecting the option, a payment module 326 may be invoked that may request payment via credit card 340, via SMS 342, via mobile phone 344, or via conventional phone 344a. A user's credit card (CC) or phone number 346 may also be required to update a user status to premium 348.

Referring now to FIG. 4, a process flow diagram of an online capture method 400 is shown according to an exemplary embodiment of the present invention. Capture method 400 may include acquiring rights (e.g., license, assignment), 402, from a content owner for content sought to be protected. The content may include, for example, digital or analog media comprising images, audio, video or any combination thereof. The content sought to be protected may be placed on a website or application, 404, which may be made accessible to an individual who may not have a corresponding license, 405. The individual or user that accesses content in an unauthorized manner (i.e., without a corresponding license) may be deemed a pirate. According to some exemplary embodiments, only a portion of the content (e.g., excerpts, vignettes, redacted versions) may be accessible by the pirate. According to other exemplary embodiments, lower quality versions of the content (e.g., decimated versions) may be accessible by the pirate.

The user may be provided access to a user or discussion forum, 406. The user's activity on the website and/or application may generate statistical or forensic evidence that may be collected and may include an internet protocol (IP) address, a date or timestamp of the user's access, the user's browser, and the user's service provider, for example. The collected statistical or forensic evidence may be associated with the user or user account, 407. Capture method 400 may include advising the user of the impropriety of accessing the unlicensed or proprietary content, 408, and may include requesting contact or identity information, 410. An unlicensed access of the content may deem the user a pirate. The contact or identity information may be posed as being for the purpose of advising the user of alternative sites or status updates if access to the website becomes interrupted, and the information may be required for an upgrade to premium status. In response to the user providing the requested contact information, the user may be updated to premium status, 411.

Capture method 400 may include interrupting access to the portion of the content, 412, which may include advising the pirate, using the received contact information, of an alternative location where the portion of the content may be accessed, 414. The alternative location may be a legitimate site or a second website or application, where additional identifying information may be obtained from the pirate. The pirate may continue to have limited access to the content at the original location for a period of time, 416. Upon acquiring sufficient identifying information for the pirate, the method may arrange for payment to be obtained therefrom, 418, for the pirate's access to the unlicensed content. Obtaining payment may involve proffering, to the pirate, civil recourse or lawful purchase of the content thereby.

FIG. 5 shows the process flow diagram of the use of online capture method 500 for a la carte online purchasing is shown according to an exemplary embodiment of the present invention. In another aspect of at least one embodiment of the present disclosure, the online purchase site offers various content for viewing and accessing including but not limited to TV shows and movies 522, music and MP3 524, printed online content, news, e-books 526 and various sports including but not limited to NFL, NBA, MLB, WWE, Soccer 528. In yet another aspect of at least one embodiment of the present disclosure, the A la Carte online purchase 502 uses honeypot method 508 for identifying and capturing the pirate. In yet another aspect of at least one embodiment of the present disclosure, owners of the content use a honeypot type sales site 510 in the process to capture the pirate 510 and to improve the search result optimization 512 the content owners advertise and target on p2p and illegal sites 514 where the chances of the identifying a pirate are high. In yet another aspect of at least one embodiment of the present disclosure, the process of capturing of pirates 500 include using a capturing type website 508 by inserting a virtual pin based predictability component to online capture 516. In yet another aspect of at least one embodiment of the present disclosure, capturing type website 508 is used for insertion on online gaming to attract and to market casinos and other interested industries 518. In yet another aspect of at least one embodiment of the present disclosure, volume purchase discount is used on a cross-platform and cross content basis 504 and bulk purchase PPV (pay-per-view) rights 506 are provided for a la carte online purchase 502. In yet another aspect of at least one embodiment of the present disclosure, online gaming sites, social media (for e.g. Facebook®, Twitter®) are used to lure the pirate to access the website. In yet another aspect of at least one embodiment of the present disclosure, once the pirate has accessed the website, information identifying the pirate is obtained. In yet another aspect of at least one embodiment of the present disclosure, the online purchase 502 can be co-branded or licensed to various card issuing companies including but not limited to American Express, Master Card and Visa 520.

Among other things, the inventions of the present disclosure provide various benefits and advantages to the owners of protectable media content. First, the methods and systems of the present invention deter and even prevent unauthorized use of media content, destabilize the market for piracy and media content theft and illegal dissemination, monetize both the media content being pirated and related/additional media content that can be sold/bundled with the pirated media content and allow owners of media content rights obtain damages and licensing fees for illegally obtained, used and viewed media content.

It should be understood, of course, that the foregoing relates to exemplary embodiments of the invention and that modifications may be made without departing from the spirit and scope of the invention as set forth in the following claims.

What is claimed is:

1. A method of detecting and preventing unauthorized use of media content, the method comprising:
providing a website containing what appears to be unlicensed or otherwise illegal media content;
providing a user with the ability to view, hear, use or access at least a portion of the unlicensed or otherwise illegal media content;
informing the user that the media content might be unlicensed or otherwise illegal or that, viewing, hearing, accessing, using or distributing the media content might be illegal; and
receiving contact or location information for the user that attempts to view, hear, access, use or distribute the media content provided on the website.

2. The method of claim 1, further comprising acquiring rights to sell, show or distribute the media content to the user from one or more owners of the media content.

3. The method of claim 1, further providing offering the user the ability to purchase rights to view, hear, access, disseminate or use the media content.

4. The method of claim 3, wherein the rights to view, hear, access, disseminate or use the media content are rights to a group of media content.

5. The method of claim 4, wherein the rights to the group of media content are offered at a discount.

6. The method of claim 1, further comprising:
interrupting the user's ability to view, hear, use or access at least a portion of the unlicensed or otherwise illegal media content;
notifying the user, using the received contact or location information, of an alternative location where the media content may be viewed, heard, used or accessed; and
providing, to the user with the ability to continue viewing, hearing, using or accessing the content for a period of time.

7. A system for detecting and preventing unauthorized use of media content, the system comprising:
an online website containing a link to media content;
a streaming media server in communication with the online website;
a web server in communication with the streaming media server;
wherein, upon receipt of information indicating a user is trying to or has accessed, downloaded, viewed or heard the media content, the website, streaming media server or web server prevents the user from accessing, viewing, hearing or downloading the media content served by the media server or web server and the website, web server or streaming media serve receives contact or location information for the user.

8. The system of claim 7, the system further comprising:
a licensing payment module which allows the user to pay for a license to at least the media content and continue to access, download, view or hear the media content.

9. The system of claim 7, the system further comprising:
a payment module wherein the payment module releases information regarding the user's contact or location information to the user and requests that the user pay for the media content.

10. The system of claim 9, where the user is notified that their actions are illegal and that payment for the media content will avoid further legal action.

11. A computer program product for detecting and preventing unauthorized use of media content, the computer program product, comprising:
a computer readable storage medium having computer readable program code embodied therewith, the computer readable program code comprising:
a computer readable program code configured to instruct an application server to:
store media content sought to be protected;
inform a user that the media content is unlicensed or that use, download or dissemination of the media content is illegal;
provide the user access to the media content; and
receive or obtain contact or location information for the user.

12. The computer program product of claim 11, wherein the computer readable program code is further configured to instruct the application server to:
restrict or prevent the user's access to the media content; and
redirect the user to a payment module.

13. The computer program product of claim 11, wherein the computer readable program code is further configured to instruct the application server to:
associate the user with location or contact information obtained from the user or from the user's access of the media content; and
store information relating to the user's activities to a database.

14. The computer program product of claim 11, wherein the computer readable program code is further configured to instruct the application server to:
provide access to the media content for a limited time; and
provide the user with the ability to pay for at least the media content in order to continue to view, access, download or use the media content.
